(19) United States
(12) Patent Application Publication
(10) Pub. No.: US 2014/0000177 A1
(43) Pub. Date: Jan. 2, 2014

(54) UNIQUE CUBIC BORON NITRIDE CRYSTALS AND METHOD OF MANUFACTURING THEM

(71) Applicant: DIAMOND INNOVATIONS, INC., Worthington, OH (US)

(72) Inventor: Kai Zhang, Westerville, OH (US)

(21) Appl. No.: 13/925,264

(22) Filed: Jun. 24, 2013

Related U.S. Application Data
(60) Provisional application No. 61/666,831, filed on Jun. 30, 2012.

(51) Int. Cl. C09K 3/14

(52) U.S. Cl. CPC C09K 3/1409
USPC 51/307

(57) ABSTRACT

A superabrasive material and method of making the superabrasive material are provided. The superabrasive material may comprise a core and an outgrown region. The core may have a single crystal structure. The outgrown region may also contain a single crystal. The single crystal may extend outwards from the core. The outgrown region may have a lower toughness index than that of the core.

### CROSS-REFERENCE TO RELATED APPLICATIONS

This application claims priority of provisional application, No. 61/666,831, filed on Jun. 30, 2012.

### TECHNICAL FIELD AND INDUSTRIAL APPLICABILITY

The present disclosure relates to hard abrasive particles and its method of manufacturing them, more specifically, to the growth of diamond nuclei or cubic boron nitride crystals.

Vitreous bond (vit-bond) grinding wheels made with cubic boron nitride (CBN) superabrasive materials are commonly used for grinding applications. Due to the nature of the CBN having hardness next to diamond, the grinding wheel made with CBN possesses low wheel wear, high grinding ratio and good surface finish. However, work piece may be burned if it is grounded at accelerated grinding condition.

Therefore, it can be seen that there is a need for a grinding tool made from superhard composite material to be used in toughness demanding operation, such as accelerate grinding condition.

### SUMMARY

In one embodiment, a superabrasive material may comprise a core having a single crystal structure; and an outgrown region extending outwards from the core, wherein the outgrown region has a lower toughness index than that of the core.

In another embodiment, a method may comprise steps of providing a plurality of hexagonal boron nitride (hBN) grains; providing a catalyst; subjecting the plurality of hBN grains and the catalyst to a first high pressure for a first time period sufficient to form a core having a single crystal structure; and subjecting the plurality of hBN grains and the catalyst to a second high pressure for a second time period sufficient to form an outgrown region extending outwards from the core.

In yet another embodiment, a superabrasive material may comprise a single crystal having a tough core and an outgrown region, wherein the outgrown region has rough, friable and blocky structure.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1A is a schematic view of a core structure with an outgrown region according to an exemplary embodiment;

FIG. 1B is a schematic view of a core structure with an outgrown region according to another exemplary embodiment;

FIG. 1C is a schematic view of a core structure with an outgrown region according to yet another exemplary embodiment;

FIG. 2A is a cross-sectional view of scanning electron micrograph (SEM) image of an exemplary embodiment of a superabrasive material;

FIG. 2B is a cross-sectional view of scanning electron micrograph (SEM) image of another exemplary embodiment of a superabrasive material;

FIG. 3 is a flow diagram illustrating a method of making superabrasive materials according to an exemplary embodiment;

FIG. 4A is an optical image of superabrasive materials at an end of early initial growth according to an exemplary embodiment;

FIG. 4B is an optical image of superabrasive materials at a full growth according to an exemplary embodiment;

FIG. 5 is a graph illustrating a special toughness index testing results on a superabrasive material compared with a commercial grade according to an exemplary embodiment; and

FIG. 6 is a cross-sectional view of scanning electron micrograph (SEM) image of ion milled exemplary embodiment of a superabravie material.

### DETAILED DESCRIPTION

An exemplary embodiment may provide an abrasive grain with a unique structure. The unique structure may possess low grinding power consumption while maintaining a competitive grinding ratio during vitreous-bond steel grinding.

An exemplary embodiment may provide an abrasive grain, such as CBN or diamond (superabrasive) grain, for example, that has a core and an outgrown region beyond the core. The grain may be grown under high pressure and high temperature which may have different profile settings between the core and the outgrown region. The core of the grain may be grown in a low growth rate. The core of the grain may possess a higher toughness index (TI) than that of the outgrown region. The overgrown region may be grown in higher growth rate than that of the core. The outgrown region may have a very rough surface morphology and may be friable. The unique structural combination of the abrasive grain may enable the vitreous-bond grinding wheel to achieve low grinding power consumption while maintaining a competitive grinding ratio in steel grinding.

Cubic boron nitride (cBN) grains are known to be produced from hexagonal boron nitride catalyst systems, such as alkali and alkaline earth metal nitrides, under high pressure and temperatures for a time period sufficient to form the cubic structure. The reaction mass is maintained under pressure and temperature conditions that thermodynamically favor the formation of cubic boron nitride crystal. The cubic boron nitride is then recovered from the reaction mass using a combination of water, acidic solutions or caustic chemicals using recovery methods known in the art. It should be noted that other methods of producing cubic boron nitride are known, i.e., cubic boron nitride prepared via a temperature gradient method or a shock wave method, and modification of the process taught in the instant application may be used to produce the abrasive grains having unique features.

Any combination of starting ingredients, which provide both the hexagonal boron nitride and the catalyst may be employed. An embodiment of the starting reaction mixture may contain a source of boron, a source of nitrogen, and a source of catalyst metal. The source of the boron may be elemental boron, hexagonal boron nitride, or material such as one of the boron hydrides which may decompose to elemental boron under conditions of the reaction. The source of nitrogen may be either hexagonal boron nitride, or a nitrogen-containing compound of a catalyst metal which may provide a source of nitrogen under reaction conditions. The catalyst metal may be employed as the elemental metal or a catalyst compound which may decompose to the catalyst metal or to the catalyst metal nitride under reaction conditions.

The process is not limited to the catalytic conversion of hexagonal boron nitride to cubic boron nitride involving only one catalyst material. Thus, mixtures of two or more catalyst materials may be employed. Those mixtures may include one or more catalyst metals, one or more catalyst nitrides or one or more combinations of metals and nitrides. In addition, alloys may also be employed in the practice of the invention. These alloys include alloys of more than one catalyst metal as well as alloys of a catalyst metal and a non-catalyst metal. Other raw material combinations are also possible.

The process may be carried out in any type of apparatus capable of producing the pressures and temperatures used to manufacture the superabrasive. An apparatus that may be used is described in U.S. Pat. Nos. 2,941,241 and 2,941,248. Examples of other apparatus include belt presses, cubic presses and split-sphere presses.

The apparatus includes a reaction volume in which controllable temperatures and pressures are provided and maintained for desired periods of time. The apparatus disclosed in the aforementioned patents is a high pressure device for insertion between the platens of a hydraulic press. The high pressure device consists of an annular member defining a substantially cylindrical reaction area, and two conical, piston-type members or punches designed to fit into the substantially cylindrical reaction area, and two conical, piston-type members or punches designed to fit into the substantially cylindrical portion of the annular member from either side of the annular member. A reaction vessel which fits into the annular member may be compressed by the two piston members or six piston members to reach the desired pressures in the manufacturing the grains having unique features. The temperature necessary is obtained by a suitable means, such as, by induction heating, direct or indirect resistive heating or other methods.

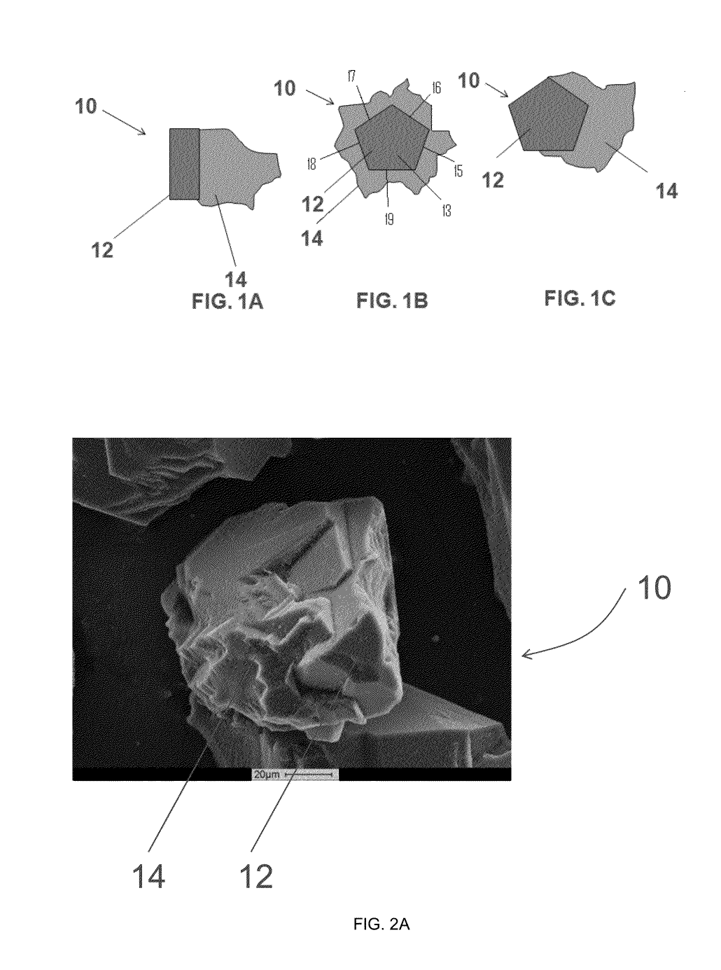

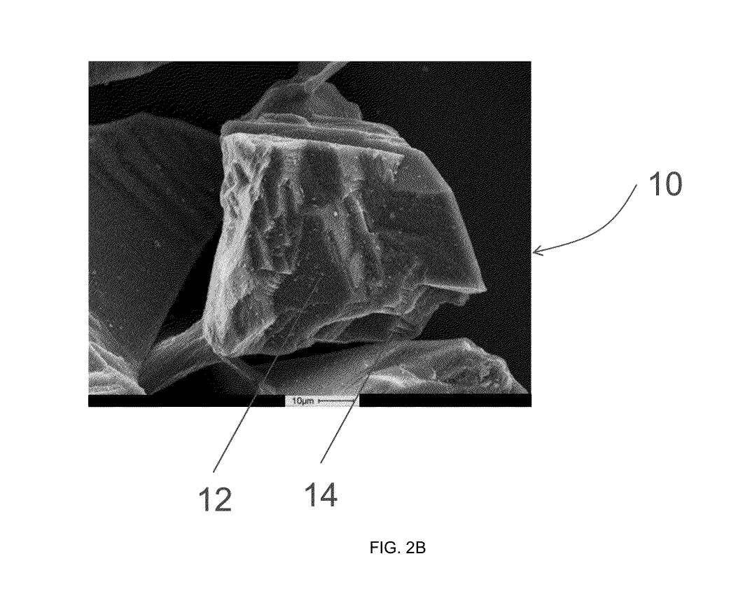

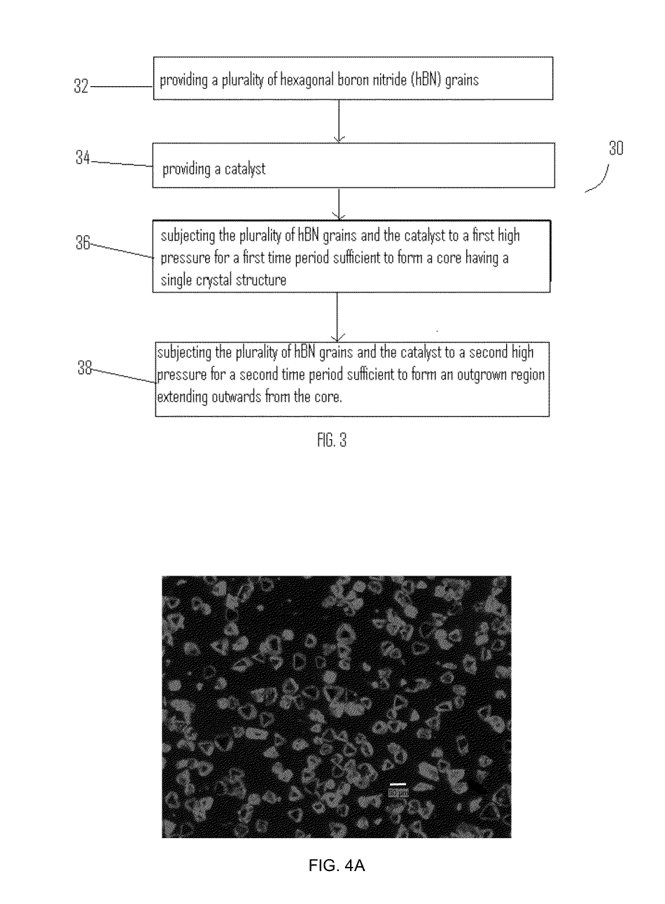

As shown in FIGS. 1A-1C, a superabrasive material 10 may comprise a core 12 and an outgrown region 14. The core 12 may have a single crystal structure. The core 12 may comprise a material selected from a group of cubic boron nitride, diamond and diamond composite materials. The outgrown region 14 may contain a single crystal extending outward from the core 12. The outgrown region 14 may be disposed at one side of the core 12 as shown in FIG. 1A according to an exemplary embodiment. The outgrown region 14 may be disposed at center of the outgrown region 14 as shown in FIG. 1B. Alternatively, the outgrown region 14 may be encroaching part of the core 12 as shown in FIG. 1C. The term “superabrasive,” as used herein, refers to materials having a Knoop hardness greater than about 4000.

The core 12 may have a single crystal structure. In one exemplary embodiment, the single crystal structure of the core 12 may have different chemical composition as the outgrown region. For example, the core may be diamond, cBN, or ceramic compounds. The outgrown region may be cBN or diamond, for example. In another exemplary embodiment, the single crystal structure may have the same chemical composition as the outgrown region, such as the single crystal structure and the outgrown region being cBN crystal. The size of the core 12 and outgrown region may range from 0.1 um to 1,000 um, for example. A ratio of radius of the core 12 to thickness of the outgrown region may be from 0.1 to 20.

The single crystal structure of the core 12 may be substantially faceted. The term “facet”, as used herein, refers to flat face on geometric shapes, such as 13 in FIG. 1B, which is defined by edges 15, 16, 17, 18, and 19. The outgrown region 14 may be blocky and rough. The crystal of the outgrown region 14 may be substantially deformed. Blocky, used herein, refers to shape and solidity as a block, appearance being similar in three dimensions.

The outgrown region 14 may have a lower toughness index than that of the core 12. Superabrasive material, such as cubic boron nitride (cBN), is often used in grinding hard ferrous alloy work pieces due to cBN's relatively non-reactivity with ferrous work pieces. Accordingly, cBN materials often are formed into grinding and machining tools. The toughness of the cBN crystals, as measured by a standard friability test, may be a factor in grinding performance. The friability test involves ball milling a quantity of product under controlled conditions and sieving the residue to measure the breakdown of the product. The toughness index (TI) is measured at room temperature. The thermal toughness index (TTI) is measured after the product has been fired at a high temperature. In many cases the tougher the crystal, the longer the life of the crystal in a grinding or machining tool and, therefore, the longer the life of the tool. This leads to less tool wear and, ultimately, lower overall tool cost.

As shown in FIG. 3, a method 30 of making superabrasive materials according to an exemplary embodiment may include steps of providing a plurality of hexagonal boron nitride (hBN) grains in a step 32; providing a catalyst in a step 34. The catalyst system chosen to grow hBN grains may include lithium compounds as catalysts, for example. An exemplary embodiment may further include subjecting the plurality of hBN grains and the catalyst to a first high pressure for a first time period sufficient to form a core having a single crystal structure in a step 36; and subjecting the plurality of hBN grains and the catalyst to a second high pressure for a second time period sufficient to form an outgrown region extending outwards from the core in a step 38. An exemplary embodiment may further include a step of cleaning products by using a combination of water, acidic solutions or caustic chemicals.

High pressure and high temperature may be configured so that the first pressure during a first time period is kept low; just above the quillibrium line between hBN and cBN at the early initial growth range. Alternatively, a first high temperature at a first high pressure for a first time period may be set at the same or higher than the second high temperature at the second high pressure for the second time period in such a way that the growth of cBN may have well-faceted feature. In an exemplary embodiment, the first high temperature and the first high pressure may range from 1600 to 2000° C. and 50 to 60 kbar, for example, respectively. The second high temperature and the second high pressure may range from 1400 to 1600° C. and from 70 to 90 kbar, for example, respectively.

After the early growth of the cBN, during the first time period at the first high pressure and high temperature, the pressure may be rapidly ramped up to a second high pressure while reducing the temperature to a second predetermined high temperature within cBN growth zone. The cBN growth zone, used herein, refers to a range of temperature and pressure under which cubic boron nitride grains are precipitated and grown under thermal dynamical stable condition. The setting of second high temperature and high pressure may help to accelerate cBN crystal growth rate that is expected to generate more growth defects in the subsequent overgrown region on the tough core of single crystal, such as cBN crystal.

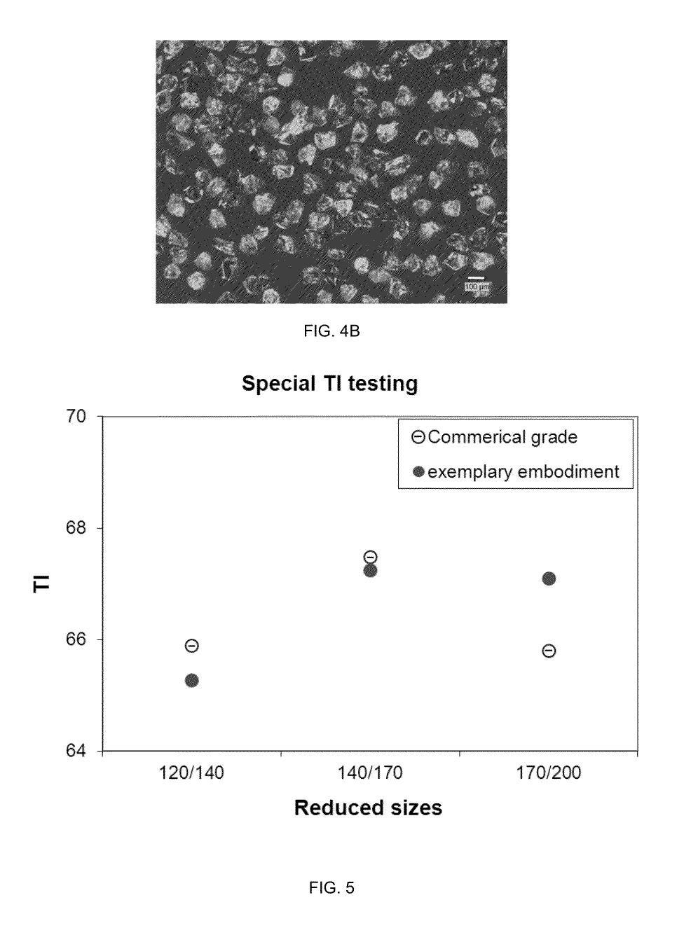

As shown in FIG. 4A, because the first high pressure may be lower than the second high pressure, the rate of cBN crystal growth may be low. The majority of cBN single crystal may be formed with well controlled shape and uniformity. The cBN crystals at the first high pressure high temperature for the first time period may have a tetrahedral or truncated tetrahedral shape with a transparent appearance and smooth facets.

As shown in FIG. 4B, the second high pressure is higher and the cBN crystals may grow in defects, such as dislocations, voids, twins, flaws, or cracks. The defects may cause the subsequent cBN growth to be even more irregular. As a result, the majority of the cBN crystals may be blocky, rough, angular, less faceted, and translucent. TI value of the overgrown cBN may be at least five points lower, for example, than that of the cBN tough cores. Over about 90% of the crystal population may lack smooth facets. The cBN crystals designed in this way may possess free cutting ability and relatively low wheel wear in grinding applications.

The mechanical strength of the produced cBN may be evaluated in terms of toughness index (TI). As shown in FIG. 5, a commercial grade of cBN such as CBN 400, may be used to compare with grains produced via the method 30 shown in FIG. 3. After the reactions shown in FIG. 3 have occurred, the grains of products may be classified by sizes using mesh sieves. For this toughness index testing, the size of 120/140 may be chosen as a starting size. The toughness index of cBN may be screened to a grit size fraction 120/140 . A predetermined amount of the sample and a steel ball are placed in a 2 mL capsule. The capsule may be set in a vibrator and subjected to vibration at a predetermined frequency, whereby the cBN particles contained in the capsule are pulverized with a steel ball. The obtained powder may be screened by a 140/170 mesh sieve. The weight of the sample remaining on the screen may be measured and expressed as percentage by weight with respect to the entire powder.

A second TI test may be conducted on a 140/170 size. After testing, a 170/200 sieve may be used to get 170/200 size of cBN after TI fracture, which is a part of the TI test. A third TI test may be performed on the size 170/200 in order to evaluate the toughness index of the size 170/200. As shown in FIG. 5, the size of 120/140 may have a lower TI value than that of the commercial grade. After TI fracture, at least a part of the outgrown region of cBN may be removed. The TI of the size 140/170 may be close to the commercial grade. After another TI fracture, at least most of the outgrown region of cBN may be removed with the core of the cBN left which has a higher TI value than that of the commercial one. FIG. 5 may give a proof that an exemplary embodiment may have a tougher core supported by high friable cBN. The pseudomorphic overgrown cBN layer may contain high defective crystals.

### Example 1

Cubic boron nitride (CBN) grains were produced using a mixture that contains a catalyst system primarily having alkali and alkaline earth metal nitride, and hydrides, and hexagonal boron nitride. In this example, Li₃N, LiOH and LiH catalyst were chosen (see U.S. Pat. No. 7,001,577B2-example 3) to grow CBN grains. The mixture was well blended in a nitrogen rich environment, and compacted into a cell by isostatic compaction. The cell was made to fit the reaction capsule of a high pressure high temperature apparatus (see US2010/0064594A1, Apparatus of the type was described in U.S. Pat. Nos. 2,941,241 and 2,941,248).

During the high temperature high pressure process (about 55 Kbar in pressure at about 1700° C., for example), hexagonal boron nitride was reacted with catalysts and formed alkaline boron nitride, an eutectic phase from which cubic boron nitrides grains were precipitated and grown under thermal dynamical stable condition (such a process is taught in U.S. Pat. No. 3,701,826). The entire process took about one hour.

HPHT conditions were set such that the pressure was kept low (˜55 kbar) which was just above the equilibrium line between hBN and CBN at the early initial growth range, whereas the growth temperature was set at a first high temperature (1800° C.) to enable growth of CBN with well-faceted features. Subsequently, the pressure was rapidly ramped up right after this early growth stage (to ˜70 kbar), while reducing the temperature to a pre-determined temperature within the CBN growth zone (1500° C.). (This setting trend is to accelerate CBN crystal growth rate so that more growth defects occur in the subsequent overgrown CBN portion on the tough cores.) This setting was kept till the end of the cBN growth cycle. Tough core, used herein, refers to a core having a high fracture strength and low friable structure.

The reaction capsule was then released from HPHT conditions and returned to room temperature and atmosphere pressure . The reaction mass of the mixture in the reaction capsule was removed into a tantalum barrel and thoroughly rinsed with hot water in order to refine the cubic boron nitride grains from residual hexagonal boron nitride. The mixture was agitated for about 10 minutes, and then the hexagonal boron nitride suspension was decanted from the barrel. Hexagonal boron nitride powder is white color and can easily be recognized during the recovery of cubic boron nitride grains. This process was repeated twice until most of hexagonal boron nitride was removed. The remaining mixture containing mostly CBN was heated under a heat lamp at 250 Watts for about 10 minutes to dry out the mixture. The mixture was then moved into a metal can which was filled with metal balls (⅛″) at a ratio of mixture/ball=1:5. The metal can was firmly sealed by clipping the cap and setting it in a Tubular mill and ball milled at 40 RPM for about 10 minutes, for example. This process broke some agglomerates as well as the weaker cubic boron nitride grains.

After ball milling, the mixture was separated from the balls using a sieve, and then put into a nickel crucible (1000 ml size). Some sodium hydroxide powder was added to cover the cubic boron nitride grains. The nickel crucible was inserted into the center of a furnace and heated for about an hour at temperature around 400° C. The crucible was then taken out of the furnace and cooled inside of a ventilation hood for one hour. The mixture was then rinsed using hot water and the reaction by-products were dissolved in solution and out of the crucible. Cubic boron nitride grains were then transferred to a TEFLON beaker. The grains were rinsed with a nitride acid solution in the beaker for about 10 minutes. The acid solution was then washed out for about 5 minutes using DI water. Finally, the grains were rinsed with Isopropanol and heat dried at 80° C. for 15 minutes. The grains were then cooled down to room temperature. The grains were classified by size using mesh sieves. They were sorted into twelve mesh sizes: +60; 60/80; 80/100; 100/120; 120/140; 140/170; 170/200; 200/230; 230/270; 270/325; 325/400; and 400-.

### Example 2

Two cells were prepared with the same chemistry as that described in example 1 and the HPHT CBN growth followed exactly the same procedure as example 1. The first cell was run under HPHT conditions until the end of early initial growth which took about 20 minutes. The HPHT conditions were back to room temperature and atmosphere pressure once the growth was terminated. This cell was taken away from the reaction capsule and in processing for a recovery of cBN grains. Recovery of cBN grains may include dissolution, acid treatment, and rinsing process. The second cell was loaded into the same reaction capsule as the first one, and followed the same growth setting as described in the example 1. This cell was run through the entire cycle time (about one hour, for example). After the reaction was terminated, this run was pulled away and recovered as described in the example 1.

CBN grains grown in the first cell had very uniform shapes such as smooth, faceted and tetrahedral or truncated tetrahedral. Overall, the CBN grains at the early initial growth are very fine in size. The CBN formed in this first cell was referred to as the core portion. In contrast, the CBN grown in the second cell had a very rough surface morphology which was blocky and irregular in shape. The majority of the CBN grains were in the size ranging from 60 to 200 microns and blocky. Almost every CBN grain after the entire reaction cycle was terminated with a thick and rough shell layer. We regard this feature as overgrown shell. The toughness index (TI) testing was performed on both types of CBN grains respectively. The CBN size employed for the testing is 120/140. The CBN core portion has TI of 72, which is about 6 points higher than that of CBN with full growth. Therefore, the CBN core portion can be regarded as hard core in monocrystalline structure.

### Example 3

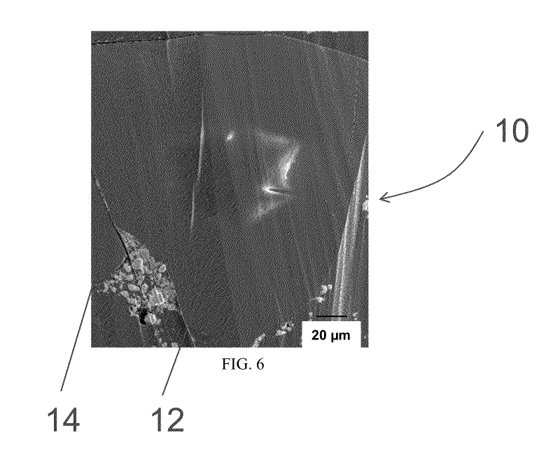

One gram of the CBN 60/80 grains of second cell cBN produced was bonded into an adhesive matrix and dried at room temperature. Subsequently, the CBN grains were subjected to ion-mill polishing so as to uncover the cross-section of the CBN grains. The polished CBN grains were then investigated using a scanning electron microscope (SEM). The FIG. 6 shows a cross-section view of such polished CBN single grain, in which a CBN core was observed that has a regular shape, smooth facet and 60-80 um in size. The overgrown shell portion outside the core was also observed. The maximum thickness of the shell was about 80 um. The core and overgrown shell were clearly distinguished by the interface.

While reference has been made to specific embodiments, it is apparent that other embodiments and variations can be devised by others skilled in the art without departing from their spirit and scope. The appended claims are intended to be construed to include all such embodiments and equivalent variations.

What is claimed is:

1. A superabrasive material comprising:
a core having a single crystal structure; and
an outgrown region extending outwards from the core, wherein the outgrown region has a lower toughness index than that of the core.

2. The superabrasive material of claim 1, wherein the outgrown region comprises a material selected from a group of cubic boron nitride, diamond and diamond composite materials.

3. The superabrasive material of claim 1, wherein the core comprises a material selected from a group of cubic boron nitride, diamond and diamond composite materials.

4. The superabrasive material of claim 1, wherein the single crystal structure of the core has different chemical compositions as that of the outgrown region.

5. The superabrasive material of claim 1, wherein the single crystal structure of the core has same chemical composition as that of the outgrown region.

6. The superabrasive material of claim 1, wherein the single crystal structure of the core is substantially faceted.

7. The superabrasive material of claim 1, wherein the outgrown region are substantially deformed.

8. The superabrasive material of claim 1, wherein the outgrown region is blocky and rough.

9. A method, comprising:
providing a plurality of hexagonal boron nitride (hBN) grains;
providing a catalyst;
subjecting the plurality of hBN grains and the catalyst to a first high pressure for a first time period sufficient to form a core having a single crystal structure; and
subjecting the plurality of hBN grains and the catalyst to a second high pressure for a second time period sufficient to form an outgrown region extending outwards from the core.

10. The method of claim 9, further comprising cleaning products by using a combination of water, acidic solutions or caustic chemicals.

11. The method of claim 9, wherein the second high pressure is higher than the first high pressure.

12. The method of claim 9, further comprising subjecting the plurality of hBN grains and the catalyst to high temperature condition.

13. The method of claim 9, further comprising subjecting the plurality of hBN grains and the catalyst to a first high temperature at the first high pressure for a first time period.

14. The method of claim 13, further comprising subjecting the plurality of hBN grains and the catalyst to a second high temperature at the second high pressure for a second time period, wherein the second high temperature is lower than the first high temperature.

15. The method of claim 13, further comprising subjecting the plurality of hBN grains and the catalyst to a second high temperature at the second high pressure for a second time period, wherein the second high temperature is the same as the first high temperature.

16. The method of claim 9, wherein the core is a single crystal of cubic boron nitride (cBN).

17. The method of claim 9, wherein the outgrown region comprises a single crystal of cubic boron nitride.

18. The method of claim 9, wherein the single crystal of cubic boron nitride of the outgrown region have rough and blocky surface.

19. The method of claim 9, wherein the core is grown at a slower growth rate than that of the outgrown region.

20. The method of claim 13, wherein the first high temperature and the first high pressure range from 1600 to 2000° C. and 50 to 60 kbar, respectively.

21. The method of claim 14, wherein the second high temperature and the second high pressure range from 1400 to 1600° C. and from 70 to 90 kbar, respectively.

22. A superabrasive material, comprising:
a single crystal having a tough core and an outgrown region, wherein the outgrown region has rough and blocky structure.

23. The superabrasive material of claim 22, wherein the outgrown region has a lower toughness index than that of the core.

24. The superabrasive material of claim 22, wherein the outgrown region comprises a material selected from a group of cubic boron nitride, diamond and diamond composite materials.

25. The superabrasive material of claim 22, wherein the core comprises a material selected from a group of cubic boron nitride, diamond and diamond composite materials.

26. The superabrasive material of claim 22, wherein the outgrown region has a lower toughness index than that of the core.

27. The superabrasive material of claim 22, wherein the single crystal structure of the core has different chemical compositions as the outgrown region.

28. The superabrasive material of claim 22, wherein the single crystal structure of the core has same chemical composition as that of the outgrown region.

29. The superabrasive material of claim 22, wherein the core has substantially faceted structure.

30. The superabrasive material of claim 22, wherein the outgrown region has substantially deformed structures.

31. A cubic boron nitride, comprising:
a core having a single crystal structure of cubic boron nitride; and
an outgrown region extending outwards from the core, wherein the outgrown region has a lower toughness index than that of the core.
